(19) United States
(12) Patent Application Publication
(10) Pub. No.: US 2026/0339729 A1
(43) Pub. Date: Oct. 29, 2026

(54) TASK EXECUTION METHOD, ELECTRONIC DEVICE, AND STORAGE MEDIUM

(71) Applicant: Beijing Baidu Netcom Science Technology Co., Ltd., Beijing (CN)

(72) Inventors: Kai LIU, Beijing (CN); Baoshan YANG, Beijing (CN); Yesong WANG, Beijing (CN)

(21) Appl. No.: 19/705,967

(22) Filed: Jun. 12, 2026

(30) Foreign Application Priority Data
Mar. 20, 2026 (CN) 202610353622.5

(51) Int. Cl. G06F 9/50; G06N 5/04

(52) U.S. Cl. CPC G06F 9/5027; G06N 5/04

(57) ABSTRACT

A task execution method, a device, and a medium are provided. The method includes: executing, by using at least one hardware device, N inference tasks of a large model according to N input data unit sequences to obtain N attention distribution information sets and N output data unit sequences, where attention information for an input data unit includes at least one candidate attention weight, and the candidate attention weight is an attention weight between a first data representation of the input data unit in a processing block and a second data representation of an output data unit in the processing block; and in response to determining that at least one first attention distribution information exists among a plurality of attention distribution information, determining at least one target ineffective data unit according to at least one first input data unit corresponding to the at least one first attention distribution information.

This application claims the benefit of Chinese Patent Application No. 202610353622.5 filed on Mar. 20, 2026, the whole disclosure of which is incorporated herein by reference.

### TECHNICAL FIELD

The present disclosure relates to the field of artificial intelligence technology, in particular to the fields of generative large models, Large Language Models (LLMs), distributed computing, and deep learning technologies, and may be applied to scenarios such as text-to-image generation and question answering. More specifically, the present disclosure provides a task execution method, an electronic device, and a storage medium.

### BACKGROUND

With the development of artificial intelligence technology, applications of large language models are continuously increasing. Large language models may not only generate output text based on input text, but also generate content in various modalities based on input multimodal data.

### SUMMARY

The present disclosure provides a task execution method, a device, and a storage medium.

According to an aspect of the present disclosure, a task execution method is provided, including: executing, by using at least one hardware device, N inference tasks of a large model according to N input data unit sequences to obtain N attention distribution information sets and N output data unit sequences, where Nis an integer greater than or equal to 1, the large model includes a plurality of processing blocks, the attention distribution information set includes at least one attention distribution information respectively corresponding to at least one input data unit in the input data unit sequence, the output data unit sequence includes at least one output data unit, the attention distribution information includes at least one attention information for the input data unit, the attention information for the input data unit includes at least one candidate attention weight, and the candidate attention weight is an attention weight between a first data representation of the input data unit in the processing block and a second data representation of the output data unit in the processing block; and in response to determining that at least one first attention distribution information satisfying a first preset condition exists among a plurality of attention distribution information, determining at least one target ineffective data unit according to at least one first input data unit respectively corresponding to the at least one first attention distribution information, where the first preset condition includes: a proportion of ineffective weights in the attention distribution information being greater than or equal to a preset proportion threshold, where the ineffective weight is a candidate attention weight less than or equal to a preset weight threshold.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to perform the method according to the present disclosure.

According to another aspect of the present disclosure, a non-transitory computer-readable storage medium having computer instructions stored thereon is provided, where the computer instructions are configured to cause a computer to perform the method according to the present disclosure.

It should be understood that the content described in this section is not intended to identify key or critical features of embodiments of the present disclosure, nor is it intended to limit the scope of the present disclosure. Other features of the present disclosure will become readily understood from the following description.

### BRIEF DESCRIPTION OF THE DRAWINGS

The accompanying drawings are provided for better understanding of the present solution and do not constitute any limitation to the present disclosure. In the accompanying drawings:

FIG. 1 is a flowchart of a task execution method according to an embodiment of the present disclosure;

FIG. 2 is a schematic diagram of attention information according to an embodiment of the present disclosure;

FIG. 3 is a schematic flowchart of a task execution method according to an embodiment of the present disclosure;

FIG. 4 is a block diagram of a task execution apparatus according to an embodiment of the present disclosure; and

FIG. 5 is a block diagram of an electronic device to which a task execution method may be applied according to an embodiment of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Accordingly, those of ordinary skill in the art will appreciate that various changes and modifications may be made to embodiments described herein without departing from the scope and spirit of the present disclosure. Also, descriptions of well-known functions and structures are omitted in the following description for clarity and conciseness.

Input data received by a large language model may include instructions and queries (also referred to as requests). The instruction may also be referred to as a system prompt or role setting, and may define a global behavior pattern, identity, or tone of the model, such that the model implicitly follows the setting throughout all subsequent generation processes. For example, if the input text is “You are an intelligent robot. Please help me solve a math problem,” “You are an intelligent robot” may serve as the instruction, and “Please help me solve a math problem” may serve as the request.

However, instructions input to the model may be ineffective. An ineffective instruction refers to an instruction that has no valid significance to the model itself, such that the model does not pay attention to such an instruction. Such an instruction cannot significantly improve the model's instruction-following capability and may even impair the model's logical consistency or generalization capability. Ineffective instructions may exhibit certain characteristics, such as extremely low difficulty and redundancy. Removing such low-difficulty and redundant data has almost no impact on model training and may even enhance model capability. For example, punctuation marks and meaningless particles such as Chinese particles “T (le)” and “HE (ne)” belong to low-difficulty or redundant data.

In related technologies, low-information redundant noise may be removed during cleaning of ineffective data. However, some instructions having high logical density and high service value may be assigned extremely low attention weights during a training process due to tokenization bias of a tokenizer or representation limitations of the model architecture. Although such instructions are important, they are ignored by the model, thereby resulting in a substantive training ineffectiveness.

Furthermore, when the model exhibits extremely low attention activation for key logic that should have been emphatically learned (such as complex causal inference and long-range semantic association), it indicates that the model has a cognitive bias with respect to such knowledge. If such high-quality instructions are not identified, the model may continuously remain in a blind spot in which it turns a blind eye to such knowledge, thereby causing degradation in model capability. After the model is trained based on one or more training methods and various training data, model behavior may still fail to meet expectations. This may be because some or all key instructions in the data input to the model are not effectively followed or are ignored. The actual reason why the model behavior fails to meet expectations is difficult to directly determine by analyzing inference results of the model. Therefore, discovering how the model follows or ignores instructions from an internal perspective of the model may greatly help improve the model capability.

From the perspective of the internal mechanism of the model, reasons why the model behavior fails to meet expectations may include a semantic dilution effect of the tokenizer and path dependence of the attention mechanism. The semantic dilution effect of the tokenizer means that many high-value instructions are fragmented into extremely scattered and low-frequency data units (tokens) during a tokenization stage, such that the model cannot effectively aggregate these scattered and low-frequency tokens when calculating attention, thereby resulting in semantic degradation. The path dependence of the attention mechanism means that the model tends to capture simple statistical patterns during an early stage of training. For high-quality instructions that require deep reasoning and should theoretically have very high weights, if the model fails to establish associations during the early stage, the model may mistakenly determine such instructions as background noise, thereby forming a cognitive inertia and further resulting in knowledge masking. It may be understood that when the input data is an input text, the data units may be referred to as tokens.

In order to effectively identify ineffective instructions, the underlying logic of the large language model in processing instruction information is briefly described below. A large language model is formed by cascading a plurality of Transformer blocks. Taking text as an example, at the beginning of an inference stage, a tokenizer parses an original text into a discrete token sequence and maps the sequence to a high-dimensional continuous vector space through an embedding layer. During this process, the vectors incorporate both static semantic representations and positional topological information. Subsequently, processing may be performed based on a self-attention mechanism. As a core hub of the large language model, the physical essence of the self-attention mechanism lies in implementing multi-dimensional dynamic interconnection among vectors. Vectors in the Transformer block are projected through linear transformation into a query vector Q, a key vector K, and a value vector V, and a correlation strength between tokens is measured through global retrieval and dot-product operations, thereby obtaining attention weights. A plurality of weights obtained based on the self-attention mechanism reflect resource allocation priorities of the model for specific information. The self-attention mechanism may be represented by Equation (1) below.

$${Attention}_{i , j} = Softmax ( \frac{{Q}_{i} * {K}_{j}^{T}}{\sqrt{{d}_{k}}} ) * V \qquad ( 1 )$$

where Attention_{i,j} may represent an attention feature between an i-th query vector Qᵢ and a j-th key vector Kⱼ, V may represent a value vector, dₖ may represent a dimensionality of the key vector,

$$Softmax ( \frac{{Q}_{i} * {K}_{j}^{T}}{\sqrt{{d}_{k}}} )$$

may represent an attention weight between the i-th query vector Qᵢ and the j-th key vector Kⱼ, and Softmax( ) is a softmax function.

In theory, the attention weights should be highly aligned with semantic salience of instructions. However, related technologies still have significant limitations in discovering high-value but ignored ineffective instructions. Related technologies are mainly implemented as hard example mining technologies based on learning dynamics, static filtering technologies based on statistics and linguistic features, and filtering technologies based on influence functions.

Hard example mining technologies based on learning dynamics include Forgetting Events technology and Error L2-Norm (EL2N) technology. In hard example mining technologies based on learning dynamics, a loss convergence trajectory of the model for a specific sample may be monitored during a training evolution process so as to evaluate data value. The main logical assumption of such technologies is that: if a certain instruction has extremely high logical density, but a loss function of the model fails to effectively decrease during an early training stage, the model is determined to have cognitive neglect or learning difficulty with respect to the sample.

The main purpose of the Forgetting Events technology is to identify data that is difficult and important for the model. The Forgetting Events technology is mainly defined as follows: during the training process, if a sample is correctly predicted by the model at a previous moment (Epoch/Batch) but is incorrectly predicted at a subsequent moment, the sample is recorded as a forgettable sample; if, once a sample is learned (correctly predicted) by the model, the sample is never incorrectly predicted in subsequent training, the sample is an unforgettable sample. The forgettable sample, namely a sample that causes the model to repeatedly fluctuate between correct prediction and incorrect prediction, may be identified as data that is difficult and crucial for training.

The main purpose of the Error L2-Norm technology is also to identify difficult data for model training so as to improve model capability. The Error L2-Norm technology is mainly defined as follows: a difficulty of a sample is measured by calculating an L2 norm between a predicted value and a true label. A sample having high L2 norm represents data that the model finds confusing or difficult to fit, and may be used for subsequent training so as to achieve better efficiency than full-data training.

The static filtering technology based on statistics and linguistic features may be implemented to filter out ineffective data using indicators such as regular expressions, keyword blacklists, token length distribution, symbol proportion, perplexity (PPL), etc. However, such technology may merely identify low-quality data in a literal sense (such as garbled characters, advertisements, and duplicate text), and thus belong to coarse-grained filtering.

The filtering technology based on influence functions may be implemented to determine an amount of change in model parameters after removal of certain data so as to evaluate importance of the data.

The hard example mining technology based on learning dynamics, the static filtering technology based on statistics and linguistic features, and the filtering technology based on influence functions mainly focus on static heuristic filtering, external model scoring, or statistical analysis based on posterior learning dynamics. Such technologies exhibit severe lag in timeliness and decision-making chains. For example, the Forgetting Events technology and the Error L2-Norm technology highly rely on real-time feedback after initiation of model training and are essentially post hoc diagnostics, and thus cannot provide prior quality insights before deployment of computationally intensive training tasks, thereby leading to low iteration efficiency during a data construction stage. Related technologies mainly observe final results indicating that the model fails to learn through loss fluctuations or error norms, but cannot isolate reasons for attention mismatch within instructions, making it difficult to identify true low-quality noise and also difficult to identify high-value cognitive blind spots caused by tokenization bias or architectural bottlenecks. Moreover, static evaluation is typically disconnected from model characteristics. Filtering mechanisms based on general rules or third-party model scoring may ignore attention allocation characteristics of the model to be trained itself, thereby resulting in a large number of latent key instructions having deep logical density and theoretically deserving high weights to be mistakenly identified as ineffective instructions and removed.

In order to efficiently and accurately identify ineffective instructions so as to reduce hardware resources wasted by the model on ineffective instructions, the present disclosure provides a task execution method, which will be described below.

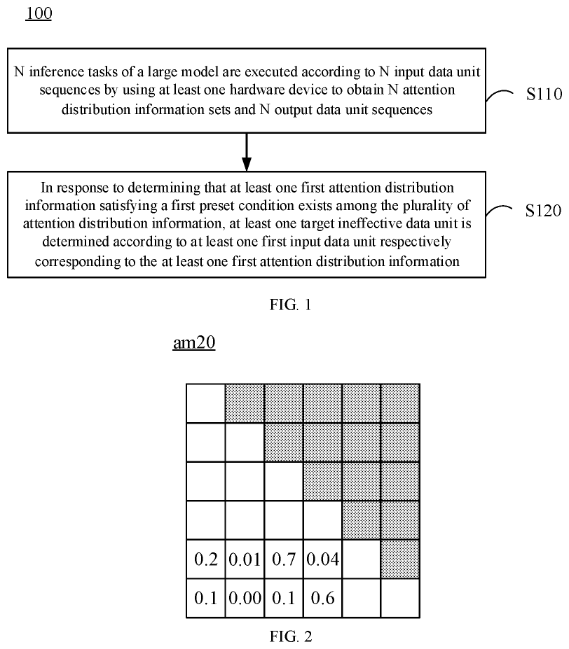

FIG. 1 is a flowchart of a task execution method according to an embodiment of the present disclosure.

As shown in FIG. 1, the method 100 may include operation S110 to operation S120.

In operation S110, N inference tasks of a large model are executed according to N input data unit sequences by using at least one hardware device to obtain N attention distribution information sets and N output data unit sequences.

In embodiments of the present disclosure, the at least one hardware device may be one or more hardware devices in a distributed computing platform. The hardware device may include an artificial intelligence chip. The artificial intelligence chip may be a general-purpose graphics processing unit (GPGPU), a tensor processing unit (TPU), or a neural processing unit (NPU).

In embodiments of the present disclosure, the input data unit sequence may be obtained based on input data of the large model. The large model may be the above-described large language model. The input data may be unimodal or multimodal data including at least one of an input text, an input image, an input audio, or an input video. The data unit may be a token. In a case where the input data is an input text, the data unit sequence may be a token sequence.

In embodiments of the present disclosure, N is an integer greater than or equal to 1.

In embodiments of the present disclosure, the large model includes a plurality of processing blocks. The processing block may be the above-described Transformer block. The plurality of processing blocks may be a plurality of cascaded processing blocks.

In embodiments of the present disclosure, the inference task of the large model may instruct the large model to generate a response result according to the input data. The response result may also be unimodal or multimodal data. For example, taking input text as an example, the input text may be “ [symbol] : [symbol] !” (“Translate: Hello!”). A label for the input text may be “Hello!”. It may be understood that the input token sequence of the input text includes more than two tokens.

In embodiments of the present disclosure, the input data unit sequence may include at least one input data unit. The N attention distribution information sets respectively correspond to the N input data unit sequences. The attention distribution information set includes at least one attention distribution information respectively corresponding to at least one input data unit in the input data unit sequence. That is, each attention distribution information corresponds to one input data unit.

The attention distribution information includes at least one attention information for the input data unit. The attention information for the input data unit includes at least one candidate attention weight. The candidate attention weight is an attention weight between a first data representation of the input data unit in the processing block and a second data representation of the output data unit in the processing block.

For example, an input data unit in the input data unit sequence may have different data representations in different processing blocks. In a first processing block of the large model, the first data representation of the input data unit may be determined based on an embedding vector of the input data unit. In a processing block subsequent to the first processing block, the first data representation of the input data unit may be determined according to an output data representation from a preceding processing block.

The processing block of the large model may process an input sequence based on a Multi-Head Self-Attention (MHSA) mechanism. After the large model decodes an 1-th output data unit, the 1-th output data unit may be concatenated to a current input of the large model to decode an (1+1)-th output data unit until an End-of-Sequence (EOS) token is decoded. Here, 1 may be an integer greater than or equal to 1. When the EOS token is decoded, the processing block of the large model determines an attention weight between a first data representation of the input data unit in the processing block and a second data representation of the decoded output data unit in the processing block, which serves as a candidate attention weight. The candidate attention weight may represent a correlation between the input data unit and the output data unit, and may also represent a degree of contribution of the input data unit to determination of the output data unit.

In a case where the large model includes a plurality of processing blocks, a quantity of the attention information for the input data unit may be related to the quantity of the processing blocks and may be plural. For example, if the large model includes t processing blocks and each processing block has h attention heads, the attention information for the input data unit may include t×h attention information. At least one attention information may be selected from the plurality of attention information to obtain the attention distribution information corresponding to the input data unit.

In operation S120, in response to determining that at least one first attention distribution information satisfying a first preset condition exists among the plurality of attention distribution information, at least one target ineffective data unit is determined according to at least one first input data unit respectively corresponding to the at least one first attention distribution information.

In embodiments of the present disclosure, the first preset condition includes that a proportion of ineffective weights in the attention distribution information is greater than or equal to a preset proportion threshold, where the ineffective weight is an attention weight less than or equal to a preset weight threshold. For example, if an attention weight is less than or equal to the preset weight threshold, the attention weight may be an ineffective weight. If an attention weight is greater than the preset weight threshold, the attention weight may be an effective weight. Taking an example in which the attention distribution information includes 100 attention weights and 50 of the 100 attention weights are ineffective weights, the proportion of ineffective weights is 50%. For another example, the preset weight threshold may be 0.05, and the preset proportion threshold may be 100%. Furthermore, the first input data unit may be determined as the target ineffective data unit. It may be understood that the preset proportion threshold being 100% is merely an example. For another example, the plurality of attention distribution information may further include a second attention distribution information failing to satisfy the first preset condition.

According to embodiments of the present disclosure, one or more attention weights for the input data unit are obtained during execution of the inference task, and the contribution of a representation of the input data unit to a representation of the output data unit may be obtained. If a certain attention distribution information includes a large number of ineffective weights, it indicates that the corresponding data unit fails to induce substantive weight activation during the inference process, further indicating that the data unit is in a marginalized state in a semantic representation space of the large model. Such a data unit is more likely to be an ineffective data unit.

Accordingly, whether a data unit is ineffective may be determined based on the attention weights actually generated during the inference process. Ineffective data units for the large model deployed on the one or more hardware devices may be objectively and accurately identified based on the actual knowledge level and reasoning capability of the model as well as the actual reasoning capability of the model that may be exerted by the at least one hardware device. As a result, ineffective instructions may be identified. Furthermore, ineffective data units may be removed from the input data unit sequence, thereby saving computational resources and storage resources required for performing attention computations involving the ineffective data units and effectively improving utilization efficiency of hardware resources.

It may be understood that the method of the present disclosure has been described above. The attention distribution information of the present disclosure will be described below.

In some embodiments, the input data may be an input text. The input text may be “ [symbol] : [symbol] !” (“Translate: Hello!”). The input text may be input into the large model such that at least one hardware device on which the large model is deployed executes an inference task to obtain an output text. The output text may be, for example, “Hello!”. It may be understood that the input text may have a label. The output text is generated by the large model and may be the same as or different from the label. The process of executing the inference task will be further described below.

The large model may include a tokenizer. After the input text is input into the large model, the tokenizer may perform tokenization on the input text to obtain a plurality of tokens. For example, the plurality of tokens may include a token for “ [symbol] [symbol] ” (“Translate”), a token for “:”, a token for “ [symbol] ” (“Hello”), and a token for “!”. It may be understood that different tokenizers may employ different tokenization methods. Another tokenizer may tokenize the input text to obtain a token for “ [symbol] ”, a token for “ [symbol] ”, a token for “:”, a token for “ [symbol] ”, a token for “ [symbol] ”, and a token for “!”. The following description will continue by taking an example in which the plurality of tokens include a token for “ [symbol] ”, a token for “:”, a token for “ [symbol] ”, and a token for “!”.

After the plurality of tokens are obtained, an embedding layer of the large model may map each token to a corresponding vector. Each vector represents a feature representation of a single token in a high-dimensional space. Since the input text is composed of a plurality of characters arranged in order, the vectors may also be arranged in the same order to form a vector sequence. The vector sequence may serve as an input to the processing block.

Within the processing block, the input is a vector sequence. According to a self-attention mechanism, correlations among the vectors in the sequence may be determined, and attention weights may be generated. Based on the weights, the model performs information aggregation and transformation on the vectors in the sequence and outputs a new vector sequence. Both the input and the output of the processing block are vector sequences, and their lengths may be identical. Furthermore, each vector in the output sequence of the processing block has already incorporated global contextual information. After stacking processing of a plurality of processing blocks, a final processing block outputs a final vector sequence.

The final vector sequence may respectively correspond to the input sequence. For example, if the input token sequence contains four tokens, the output may include four vectors. At this point, a first decoded token has not yet been generated and may be predicted based on the last vector in the vector sequence. For example, the model may extract the last vector in the vector sequence (corresponding to the position of “!” at the end of the input sequence). This vector aggregates the semantic information of all preceding tokens and may serve as a basis for predicting a “next token”. The vector may be mapped to a logits vector through a linear transformation and then converted into a probability distribution through a softmax function. Based on the probability distribution, the model may select the token having the highest probability as a prediction result, such as a token for “Hello”, which may be the first decoded token.

During an autoregressive generation process, the generated token (the token for “Hello”) is converted into a new vector and appended to the end of the original input vector sequence, thereby forming a new input sequence. The expanded sequence is then processed by the model again to predict a next token until an end-of-sequence token is generated or a preset length is reached, thereby ultimately forming a complete output text (e.g., “Hello!”).

An attention weight matrix according to the present disclosure will be further described below with reference to FIG. 2.

FIG. 2 is a schematic diagram of attention information according to an embodiment of the present disclosure.

As shown in FIG. 2, after processing of the tokenizer, a plurality of input tokens of the input text “ [symbol] : [symbol] ” may be obtained. The plurality of input tokens include a token for “ [symbol] ”, a token for “:”, a token for “ [symbol] ”, and a token for “!”. After the large model decodes the end-of-sequence token, a plurality of output tokens may be obtained. The plurality of output tokens include a token for “Hello” and a token for “!”. It may be understood that the output text for the input text may be Hello!.

Inference of the large model may include a plurality of processing blocks. After execution of the inference task is completed, an attention weight matrix of a processing block may be obtained. During a decoding process in which the end-of-sequence token is decoded, the input vector sequence received by the processing block may include a data representation of “ [symbol] ”, a data representation of “:”, a data representation of “ [symbol] ”, a data representation of the input “!”, a data representation of “Hello”, and a data representation of the decoded “!”. It may be understood that the data representation of “ [symbol] ”, the data representation of “:”, the data representation of “ [symbol] ”, and the data representation of the input “!” are also data representations of the input tokens in the processing block and may respectively serve as first data representations. The data representation of “Hello” and the data representation of the decoded “!” are also data representations of the output tokens in the processing block and may respectively serve as second data representations.

The attention weight matrix am20 includes a plurality of attention information. Among the plurality of attention information, the attention information for “ [symbol] ” includes an attention weight “0.2” between the data representation of “ [symbol] ” and the data representation of “Hello”, and an attention weight “0.1” between the data representation of “ [symbol] ” and the data representation of the decoded “!”. Among the plurality of attention weights, the attention information for “:” includes an attention weight “0.01” between the data representation of “:” and the data representation of “Hello”, and an attention weight “0.00” between the data representation of “:” and the data representation of “!”. The attention information for “ [symbol] ” includes an attention weight “0.7” between the data representation of “ [symbol] ” and the data representation of “Hello”, and an attention weight “0.1” between the data representation of “ [symbol] ” and the data representation of “!”. The attention information for the input “!” includes an attention weight “0.04” between the data representation of “!” and the data representation of “Hello”, and an attention weight “0.6” between the data representation of the input “!” and the data representation of the output “!”.

In some embodiments, a quantity of the attention information for the input data unit may be configured.

For example, if the quantity of the attention information for the input data unit is configured as 1, one processing block may be randomly selected, and the corresponding attention information may be obtained as the attention distribution information. Taking the attention information for “:” shown in FIG. 2 as an example, the attention information may serve as the attention distribution information. If the preset weight threshold is 0.05 and the preset proportion threshold is 1, both attention weights in the attention distribution information are less than the preset weight threshold, and the proportion of ineffective weights (i.e., 1) is equal to the preset proportion threshold. Accordingly, the attention distribution information satisfies the first preset condition and may serve as the first attention distribution information. The token for “:” may serve as the first input data unit.

For another example, if the quantity of the attention information for the input data unit is configured as 3, three processing blocks may be selected, and the corresponding attention information may be obtained as the attention distribution information. Taking the attention distribution information for “:” as an example, the attention distribution information may include three attention information. One of the three attention information may be the attention information for “:” shown in FIG. 2. If the preset weight threshold is 0.05, the preset proportion threshold is 1, and the attention distribution information includes four attention weights greater than the preset weight threshold, the proportion of ineffective weights (i.e., ⅔) is less than the preset proportion threshold. Accordingly, the attention distribution information fails to satisfy the first preset condition, and the token for “:” may serve as a second input data unit or may serve as an effective data unit. It may be understood that the attention distribution information set corresponding to the input token sequence may include an attention distribution information for the token of “ [symbol] ”, an attention distribution information for the token of “:”, an attention distribution information for the token of “ [symbol] ”, and an attention distribution information for the token of “!”.

It may be understood that the first input data unit may serve as the target ineffective data unit, or the target ineffective data unit may be selected from one or more first input data units, which will be described below.

It may be understood that the attention information according to the present disclosure has been described above with reference to FIG. 2. The method of the present disclosure will be further described below.

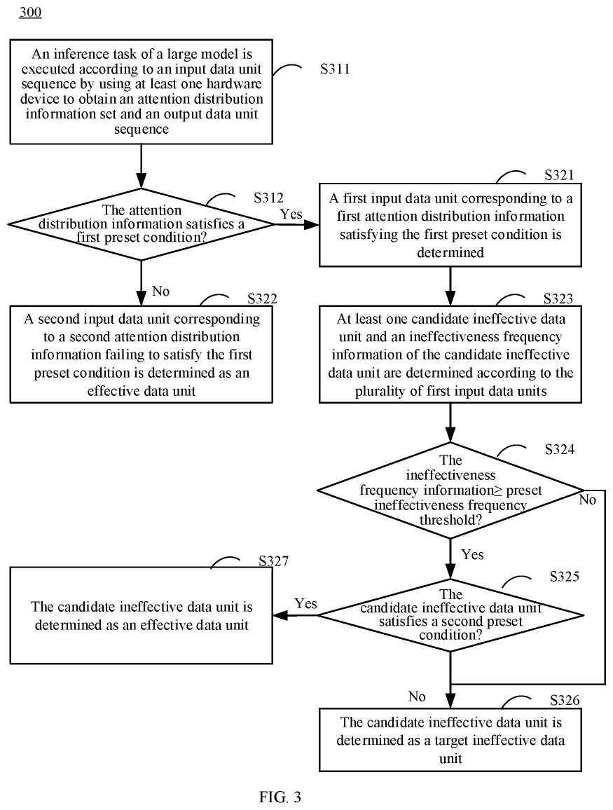

FIG. 3 is a schematic flowchart of a task execution method according to an embodiment of the present disclosure.

As shown in FIG. 3, the method 300 may include operation S311, operation S312, and operation S321 to operation S327.

In operation S311, an inference task of a large model is executed according to an input data unit sequence by using at least one hardware device to obtain an attention distribution information set and an output data unit sequence. The attention distribution information set includes at least one attention distribution information respectively corresponding to at least one input data unit in the input data unit sequence.

In operation S312, it is determined whether the attention distribution information satisfies a first preset condition. As described above, the first preset condition includes that the proportion of ineffective weights in the attention distribution information is greater than or equal to a preset proportion threshold. Still taking the example in which the preset proportion threshold is 1 and the preset weight threshold is 0.05, operation S321 may be performed in response to determining that a plurality of candidate attention weights in the attention distribution information are each less than or equal to 0.05, while operation S322 may be performed in response to determining that at least one of the candidate attention weights in the attention distribution information is greater than 0.05.

In operation S321, a first input data unit corresponding to a first attention distribution information satisfying the first preset condition is determined. The first input data unit may be a factually ineffective data unit, an unreasonably ineffective data unit, or a low-frequency redundant and ignorable data unit.

In operation S322, a second input data unit corresponding to a second attention distribution information failing to satisfy the first preset condition is determined as an effective data unit.

It may be understood that operations S311 to S312 may be performed N times to execute N inference tasks in parallel or in series. The N input data unit sequences used in execution of the N inference tasks include M input data units. Taking an example in which N is greater than 1 and a plurality of first input data units have been determined, identical data units may exist among the plurality of first input data units, that is, at least one of the plurality of first input data units may appear multiple times during the N inference processes, and the proportion of ineffective weights in the corresponding attention distribution information is large.

Subsequently, operation S323 to operation S327 may be performed on the plurality of first input data units to determine at least one target ineffective data unit according to the at least one first input data unit.

In operation S323, at least one candidate ineffective data unit and an ineffectiveness frequency information of the candidate ineffective data unit are determined according to the plurality of first input data units.

The plurality of first input data units may be de-duplicated, thereby obtaining at least one candidate ineffective data unit.

The ineffectiveness frequency information may be a High-frequency Ineffectiveness Ratio (HIR). The ineffectiveness frequency information may be determined according to a first quantity of the candidate ineffective data unit and a second quantity of the candidate ineffective data unit, where the first quantity is a quantity of the candidate ineffective data unit among the plurality of first input data units, and the second quantity is a quantity of the candidate ineffective data unit among the M input data units. For example, if a data unit appears ten times among the M input data units and appears eight times among the plurality of first input data units, the second quantity may be 10 and the first quantity may be 8. The data unit may serve as a candidate ineffective data unit, and the corresponding ineffectiveness frequency information may be determined by dividing the first quantity by the second quantity, namely 0.8. For another example, if another data unit appears 20 times among the M input data units, the second quantity may be 20; if the other data unit appears once among the plurality of first input data units, the first quantity may be 1. The other data unit may serve as a candidate ineffective data unit, and the corresponding ineffectiveness frequency information may be determined by dividing the first quantity by the second quantity, namely 0.05.

Subsequently, a target ineffective data unit is determined from the at least one candidate ineffective data unit according to at least one of: at least one type information or at least one ineffectiveness frequency information. The type information indicates a type of the candidate ineffective data unit. Taking an ineffective token as an example, the type information of the token may indicate that the token is a punctuation mark, a particle, a verb, a noun, or a logical connective. The logical connective may be “and”, “or”, or the like. Details will be described below with reference to operation S324 to operation S327.

In operation S324, it is determined whether the ineffectiveness frequency information is greater than or equal to a preset ineffectiveness frequency threshold.

In response to determining that the ineffectiveness frequency information of the candidate ineffective data unit is greater than or equal to the preset ineffectiveness frequency threshold, operation S325 is performed. In operation S325, it is determined whether the candidate ineffective data unit satisfies a second preset condition.

The second preset condition includes at least one of: an input effectiveness information of the candidate ineffective data unit indicating that the candidate ineffective data unit is effective; a type information of the candidate ineffective data unit indicating that the candidate ineffective data unit is a verb, a logical connective, or a noun. The input effectiveness information may be input by a user or an expert and may indicate whether the candidate ineffective data unit is effective or ineffective. Furthermore, if the type of the candidate ineffective data unit is a verb, a logical connective, or a noun, it indicates that the data unit may have actual semantics that are not effectively captured by the model, and therefore is an unreasonably ineffective data unit.

In response to determining that the candidate ineffective data unit fails to satisfy the second preset condition, operation S326 is performed. In operation S326, the candidate ineffective data unit is determined as a target ineffective data unit. If the type information of the candidate ineffective data unit indicates that the candidate ineffective data unit is a punctuation mark or a particle, the candidate ineffective data unit is a low-information-entropy data unit and may be determined as natural noise that is easily ignored in character semantics, belonging to a factually ineffective data unit. Furthermore, if the input effectiveness information indicates that the data unit is ineffective, the candidate ineffective data unit may be directly determined as a target ineffective data unit.

In response to determining that the candidate ineffective data unit satisfies the second preset condition, operation S327 is performed. In operation S327, the candidate ineffective data unit is determined as an effective data unit. If the type information of the candidate ineffective data unit indicates that the candidate ineffective data unit is a verb, a logical connective, or a noun, the candidate ineffective data unit is an unreasonably ineffective data unit, which is caused by insufficient model capability or by failure of the hardware resources of the hardware device to fully exert the performance of the model. Furthermore, if the input effectiveness information indicates that the data unit is effective, the candidate ineffective data unit may be directly determined as an effective data unit. In addition, it is possible to preset certain core verbs and key entity nouns, such that some verbs or less important nouns may be treated as ineffective data units, thereby further reducing hardware resource overhead.

It may be understood that the present disclosure has been described above by taking an example in which the ineffectiveness frequency information is greater than the preset ineffectiveness frequency threshold. However, the present disclosure is not limited thereto, and the ineffectiveness frequency information may also be less than the preset ineffectiveness frequency threshold, which will be described below.

In response to determining that the ineffectiveness frequency information of the candidate ineffective data unit is less than the preset ineffectiveness frequency threshold, operation S326 described above is performed. For example, in a case where the ineffectiveness frequency information is less than the preset ineffectiveness frequency threshold, the candidate ineffective data unit may be regarded as a low-frequency, redundant and ignorable data unit, and may serve as a target ineffective data unit.

According to embodiments of the present disclosure, the lagging nature of posterior statistics may be overcome, and a prior determination of instruction effectiveness may be achieved. Related technologies represented by Forgetting Events technology and Error L2-Norm technology belong to posterior evaluation paradigm and must rely on statistics of loss function trajectories after the initiation of model training. However, model training requires a large amount of hardware resources. Before costly computing resources are invested, developers are unable to predict the effectiveness of constructed data based on posterior statistical technologies, resulting in an apparent lag in timeliness. In the present disclosure, microscopic attention distributions may be extracted during the inference stage, thereby achieving a prior evaluation of instruction effectiveness. Without undergoing a complete training cycle, it is possible to accurately identify ineffective instructions during a data preprocessing stage or an inference stage, thereby avoiding waste of computing resources caused by cognitive idling at the source and significantly improving the iteration efficiency of data engineering.

It may be understood that several methods for determining the target ineffective data unit have been described above. A method for improving hardware resource utilization based on the target ineffective data unit will be described below.

In some embodiments, the above-described method may further include: removing the target ineffective data unit from the input data unit sequence to obtain a first updated data unit sequence. After removal of the ineffective data unit, during inference or training process of the large model, the attention computation in each processing block may be significantly reduced, and hardware resource overhead such as computation and storage may be effectively reduced. Accordingly, the hardware resource overhead may be reduced when an inference task or a training task of the large model is executed according to the first updated data unit sequence, while the accuracy of inference or training may remain unchanged or may even be improved.

It may be understood that the method for removing the target ineffective data unit has been described above. However, the present disclosure is not limited thereto. The input data may include instructions and requests. Correspondingly, the input data unit sequence of the input data may include an input instruction data unit subsequence and an input query data unit subsequence. If a large quantity of ineffective data units exist in the input instruction data unit subsequence, the input instruction data unit subsequence may be removed, which will be described below.

In some embodiments, the above-described method may further include: in response to determining that the quantity of the target ineffective data unit in the input instruction data unit subsequence is greater than or equal to a preset quantity threshold, determining the input instruction data unit subsequence as an ineffective instruction data unit subsequence; and removing the ineffective instruction data unit subsequence from the input data unit sequence to obtain a second updated data unit sequence. The inference task or training task may then be executed based on the second updated data unit sequence. During the execution of the inference task or training task, when the input instruction data unit subsequence has been removed, the quantity of data units to be processed by the model may be significantly reduced, and the attention computation in each processing block may be significantly reduced, thereby effectively reducing hardware resource overhead such as computation and storage. Accordingly, the hardware resource overhead may be reduced when an inference task or a training task of the large model is executed according to the second updated data unit sequence.

It may be understood that if an instruction includes a large quantity of ineffective weights, it is difficult to induce substantive weight activation during the inference process. Such an instruction is in a marginalized state in the semantic representation space of the model. When the model is still able to maintain consistency of an output objective in the absence of such token features, the instruction sequence may serve as an ineffective instruction with respect to a current cognitive level of the model.

It may be understood that the implementation of removing one or more data units may include removing characters from an input text, removing image patches from an input image, or removing audio segments from an input audio.

In some embodiments, the input instruction data unit subsequence is an input instruction token subsequence, and the input instruction token subsequence is determined according to an input instruction sub-text in the input data. The instruction may be in a text form, and correspondingly, the input instruction data unit subsequence may be an input instruction token subsequence.

It may be understood that the processing method for an input sequence containing the target ineffective data unit has been described above. The candidate ineffective data unit satisfying the second preset condition will be described below.

In some embodiments, the above-described method may further include: in response to determining that the candidate ineffective data unit satisfies the second preset condition, obtaining at least one training data unit sequence according to the candidate ineffective data unit.

The at least one training data unit sequence includes at least one of: at least one first training data unit sequence or at least one second training data unit sequence. The first training data unit sequence is an input data unit sequence including the candidate ineffective data unit, and the second training data unit sequence is generated according to the candidate ineffective data unit. A sequence that includes the candidate ineffective data unit satisfying the second preset condition may be used for training. Alternatively, a new sequence may be generated based on the candidate ineffective data unit satisfying the second preset condition and used for training.

A training task of the large model may be executed by using at least one hardware device according to the input data unit sequence including the candidate ineffective data unit, so as to increase at least one attention weight in the attention distribution information corresponding to the candidate ineffective data unit. Thus, the training objective includes increasing the attention weight of the candidate ineffective data unit, so that the cognitive capability and reasoning capability of the model may be effectively improved.

According to embodiments of the present disclosure, data synthesis may be guided based on the candidate ineffective data unit satisfying the second preset condition. By introducing the high-frequency ineffectiveness ratio (HIR), an evaluation mechanism is established between objective semantic value and subjective model cognition. Such mechanism is capable of identifying high-quality instructions that are considered important by humans but ignored by the model. Furthermore, targeted synthesis may be performed based on the ignored high-quality instructions, such that the model may be trained in a targeted manner to improve model capability.

It may be understood that the method according to the present disclosure has been described above. The input data according to the present disclosure will be described below.

In some embodiments, the input data unit sequence is determined based on at least one of an input text, an input image, an input audio, or an input video, and the output data unit sequence is configured to be converted into at least one of an output text, an output image, an output audio, or an output video.

For example, the input data unit sequence includes an input token sequence determined based on an input text, and the output data unit sequence is an output token sequence. Executing an inference task of the large model according to the input data unit sequence by using at least one hardware device includes: performing tokenization on the input text to obtain an input token sequence; executing an inference task of the large model according to the input token sequence by using the at least one hardware device to obtain an output token sequence for the input token sequence and at least one attention distribution information respectively corresponding to at least one input token in the input token sequence; and obtaining an output text according to the output token sequence.

For example, the input data unit sequence includes an input image data unit sequence determined based on an input image, and the output data unit sequence is an output image data unit sequence. Executing an inference task of the large model according to the input data unit sequence by using the at least one hardware device includes: performing patch embedding on the input image to obtain an input image data unit sequence; executing an inference task of the large model according to the input image data unit sequence by using the at least one hardware device to obtain an output image data unit sequence for the input image data unit sequence and at least one attention distribution information respectively corresponding to at least one input image data unit in the input image data unit sequence; and obtaining an output image according to the output image data unit sequence.

According to embodiments of the present disclosure, latent high-value data may be mined to improve model capability. For example, ineffective instructions may be mined from massive data to discover weaknesses of a model, especially weaknesses of the model deployed on the current hardware device. By performing semantic reconstruction, chain-of-thought (CoT) guidance, or sampling weight compensation on such ignored instructions in a targeted manner, model capability may be improved. For example, instructions having extremely low attention weights but high semantic complexity may be defined as cognitive difficulty points. Through strategies such as curriculum learning, the model may be forced to increase attention to such instructions during subsequent training, thereby improving model capability in a targeted manner.

According to embodiments of the present disclosure, a comprehensive and objective feedback loop for a data production workflow is constructed. Weaknesses of a model may be mined according to the attention distribution of the model with respect to specific instructions, and training data may be synthesized in a targeted manner to guide data production. A feedback-based data evolution pipeline may be constructed, in which identified ineffective instructions (i.e., high-value semantic regions that are ignored) are transformed into sampling guidance for synthetic data. The synthesis of such data is increased for the cognitive weak links exhibited by the model. Thus, it may be ensured that the synthetic data is more than low-quality repetition and instead serve as an effective expansion of the cognitive boundaries of the model.

It may be understood that the method according to the present disclosure has been described above. An apparatus according to the present disclosure will be described below.

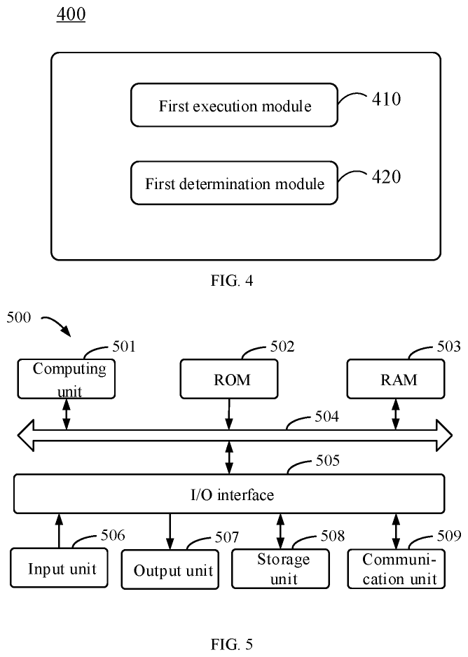

FIG. 4 is a schematic diagram of a task execution apparatus according to an embodiment of the present disclosure.

As shown in FIG. 4, the apparatus 400 includes a first execution module 410 and a first determination module 420.

The first execution module 410 is configured to execute N inference tasks of a large model according to N input data unit sequences by using at least one hardware device to obtain N attention distribution information sets and N output data unit sequences, where N is an integer greater than or equal to 1, and the large model includes a plurality of processing blocks. The attention distribution information set includes at least one attention distribution information respectively corresponding to at least one input data unit in the input data unit sequence. The output data unit sequence includes at least one output data unit. The attention distribution information includes at least one attention information for the input data unit, and the attention information for the input data unit includes at least one candidate attention weight. The candidate attention weight is an attention weight between a first data representation of the input data unit in the processing block and a second data representation of the output data unit in the processing block.

The first determination module 420 is configured to, in response to determining that at least one first attention distribution information satisfying a first preset condition exists among the plurality of attention distribution information, determine at least one target ineffective data unit according to at least one first input data unit respectively corresponding to the at least one first attention distribution information. The first preset condition includes that a proportion of ineffective weights in the attention distribution information is greater than or equal to a preset proportion threshold, where the ineffective weight is a candidate attention weight less than or equal to a preset weight threshold.

In some embodiments, the at least one first input data unit includes a plurality of first input data units, identical data units exist among the plurality of input data units, and the N input data unit sequences include M input data units. The first determination module 420 includes: an obtaining sub-module configured to obtain at least one candidate ineffective data unit and an ineffectiveness frequency information of the candidate ineffective data unit according to the plurality of first input data units. The ineffectiveness frequency information is determined according to a first quantity of the candidate ineffective data unit and a second quantity of the candidate ineffective data unit, where the first quantity is a quantity of the candidate ineffective data unit among the plurality of first input data units, and the second quantity is a quantity of the candidate ineffective data unit among the M input data units. The first determination module 420 further includes a first determination sub-module configured to determine a target ineffective data unit from the at least one candidate ineffective data unit according to at least one of: at least one type information or at least one ineffectiveness frequency information. The type information indicates a type of the candidate ineffective data unit.

In some embodiments, the first determination sub-module includes at least one of: a first determination unit configured to, in response to determining that the ineffectiveness frequency information of the candidate ineffective data unit is greater than or equal to a preset ineffectiveness frequency threshold and determining that the candidate ineffective data unit fails to satisfy a second preset condition, determine the candidate ineffective data unit as a target ineffective data unit; or a second determination unit configured to, in response to determining that the ineffectiveness frequency information of the candidate ineffective data unit is less than the preset ineffectiveness frequency threshold, determine the candidate ineffective data unit as a target ineffective data unit. The second preset condition includes at least one of: an input effectiveness information of the candidate ineffective data unit indicating that the candidate ineffective data unit is effective; the candidate ineffectiveness frequency information being greater than or equal to a first preset ineffectiveness frequency threshold, and determining that the type information of the candidate ineffective data unit indicates that the candidate ineffective data unit is a verb, a logical connective, or a noun.

In some embodiments, the apparatus 400 may further include: a first removal module configured to remove the target ineffective data unit from the input data unit sequence to obtain a first updated data unit sequence, such that hardware resource overhead is reduced when an inference task or a training task of a large model is executed according to the first updated data unit sequence.

In some embodiments, the input data unit sequence includes an input instruction data unit subsequence and an input query data unit subsequence. The apparatus 400 may further include: a second determination module configured to, in response to determining that a quantity of the target ineffective data unit in the input instruction data unit subsequence is greater than or equal to a preset quantity threshold, determine the input instruction data unit subsequence as an ineffective instruction data unit subsequence; and a second removal module configured to remove the ineffective instruction data unit subsequence from the input data unit sequence to obtain a second updated data unit sequence, such that hardware resource overhead is reduced when an inference task or a training task of the large model is executed according to the second updated data unit sequence.

In some embodiments, the input instruction data unit subsequence is an input instruction token subsequence, and the input instruction token subsequence is determined according to an input instruction sub-text in the input data.

In some embodiments, the apparatus 400 may further include: an obtaining module configured to, in response to determining that the candidate ineffective data unit satisfies the second preset condition, obtain at least one training data unit sequence according to the candidate ineffective data unit, where the at least one training data unit sequence includes at least one of: at least one first training data unit sequence or at least one second training data unit sequence, the first training data unit sequence is an input data unit sequence including the candidate ineffective data unit, and the second training data unit sequence is generated according to the candidate ineffective data unit; and a second execution module configured to execute, by using the at least one hardware device, a training task of the large model according to the input data unit sequence including the candidate ineffective data unit to increase at least one attention weight in the attention distribution information corresponding to the candidate ineffective data unit.

In some embodiments, the input data unit sequence is determined based on at least one of an input text, an input image, an input audio, or an input video, and the output data unit sequence is configured to be converted into at least one of an output text, an output image, an output audio, or an output video.

In some embodiments, the input data unit sequence includes an input token sequence determined based on the input text, and the output data unit sequence is an output token sequence. The first execution module 410 includes: a tokenization sub-module configured to perform tokenization on the input text to obtain an input token sequence; an execution sub-module configured to execute an inference task of the large model according to the input token sequence by using the at least one hardware device to obtain an output token sequence for the input token sequence and at least one attention distribution information respectively corresponding to at least one input token in the input token sequence; and an obtaining sub-module configured to obtain an output text according to the output token sequence.

In the technical solutions of the present disclosure, the collection, storage, use, processing, transmission, provision, and disclosure of user personal information involved are all in compliance with relevant laws and regulations and do not violate public order and good morals.

According to an embodiment of the present disclosure, the present disclosure further provides an electronic device, a readable storage medium, and a computer program product.

FIG. 5 shows a schematic block diagram of an exemplary electronic device 500 that may be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 5, the electronic device 500 includes a computing unit 501 which may perform various appropriate actions and processes according to a computer program stored in a read-only memory (ROM) 502 or a computer program loaded from a storage unit 508 into a random access memory (RAM) 503. In the RAM 503, various programs and data necessary for an operation of the electronic device 500 may also be stored. The computing unit 501, the ROM 502 and the RAM 503 are connected to each other through a bus 504. An input/output (I/O) interface 505 is also connected to the bus 504.

A plurality of components in the electronic device 500 are connected to the input/output (I/O) interface 505, including: an input unit 506, such as a keyboard, or a mouse; an output unit 507, such as displays or speakers of various types; a storage unit 508, such as a disk, or an optical disc; and a communication unit 509, such as a network card, a modem, or a wireless communication transceiver. The communication unit 509 allows the electronic device 500 to exchange information/data with other devices through a computer network such as Internet and/or various telecommunication networks.

The computing unit 501 may be various general-purpose and/or dedicated processing assemblies having processing and computing capabilities. Some examples of the computing units 501 include, but are not limited to, a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, etc. The computing unit 501 executes various methods and processes described above, such as the task execution method. For example, in some embodiments, the task execution method may be implemented as a computer software program which is tangibly embodied in a machine-readable medium, such as the storage unit 508. In some embodiments, the computer program may be partially or entirely loaded and/or installed in the electronic device 500 via the ROM 502 and/or the communication unit 509. The computer program, when loaded in the RAM 503 and executed by the computing unit 501, may execute one or more steps in the task execution method described above. Alternatively, in other embodiments, the computing unit 501 may be used to perform the task execution method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the data processing method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory, a read only memory, an erasable programmable read-only memory (EPROM) or a flash memory, an optical fiber, a compact disk read-only memory (CD-ROM), an optical storage device, a magnetic storage device, or any suitable combination of the above.

In order to provide interaction with the user, the systems and technologies described here may be implemented on a computer including a display device (for example, a cathode ray tube (CRT) or liquid crystal display (LCD)) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A task execution method, comprising:
executing, by using at least one hardware device, N inference tasks of a large model according to N input data unit sequences to obtain N attention distribution information sets and N output data unit sequences, wherein Nis an integer greater than or equal to 1, the large model comprises a plurality of processing blocks, the attention distribution information set comprises at least one attention distribution information respectively corresponding to at least one input data unit in the input data unit sequence, the output data unit sequence comprises at least one output data unit, the attention distribution information comprises at least one attention information for the input data unit, the attention information for the input data unit comprises at least one candidate attention weight, and the candidate attention weight is an attention weight between a first data representation of the input data unit in the processing block and a second data representation of the output data unit in the processing block; and
in response to determining that at least one first attention distribution information satisfying a first preset condition exists among a plurality of attention distribution information, determining at least one target ineffective data unit according to at least one first input data unit respectively corresponding to the at least one first attention distribution information,
wherein the first preset condition comprises: a proportion of ineffective weights in the attention distribution information being greater than or equal to a preset proportion threshold, wherein the ineffective weight is a candidate attention weight less than or equal to a preset weight threshold.

2. The method of claim 1, wherein the at least one first input data unit comprises a plurality of first input data units, identical data units exist among the plurality of input data units, and the N input data unit sequences comprise M input data units,
wherein the determining at least one target ineffective data unit according to at least one first input data unit respectively corresponding to the at least one first attention distribution information comprises:
obtaining at least one candidate ineffective data unit and an ineffectiveness frequency information of the candidate ineffective data unit according to the plurality of first input data units, wherein the ineffectiveness frequency information is determined according to a first quantity of the candidate ineffective data unit and a second quantity of the candidate ineffective data unit, the first quantity is a quantity of the candidate ineffective data unit among the plurality of first input data units, and the second quantity is a quantity of the candidate ineffective data unit among the M input data units; and
determining a target ineffective data unit from the at least one candidate ineffective data unit according to at least one of: at least one type information or at least one ineffectiveness frequency information, wherein the type information indicates a type of the candidate ineffective data unit.

3. The method of claim 2, wherein the determining a target ineffective data unit from the at least one candidate ineffective data unit comprises at least one of:
determining the candidate ineffective data unit as the target ineffective data unit in response to determining that the ineffectiveness frequency information of the candidate ineffective data unit is greater than or equal to a preset ineffectiveness frequency threshold and determining that the candidate ineffective data unit fails to satisfy a second preset condition; and
determining the candidate ineffective data unit as the target ineffective data unit in response to determining that the ineffectiveness frequency information of the candidate ineffective data unit is less than the preset ineffectiveness frequency threshold,
wherein the second preset condition comprises at least one of:
an input effectiveness information of the candidate ineffective data unit indicating that the candidate ineffective data unit is effective; and
the candidate ineffectiveness frequency information being greater than or equal to a first preset ineffectiveness frequency threshold, and determining that the type information of the candidate ineffective data unit indicates that the candidate ineffective data unit is a verb, a logical connective, or a noun.

4. The method of claim 3, further comprising:
removing the target ineffective data unit from the input data unit sequence to obtain a first updated data unit sequence, such that hardware resource overhead is reduced when an inference task or a training task of the large model is executed according to the first updated data unit sequence.

5. The method of claim 3, wherein the input data unit sequence comprises an input instruction data unit subsequence and an input query data unit subsequence, the method further comprising:
determining the input instruction data unit subsequence as an ineffective instruction data unit subsequence in response to determining that a quantity of the target ineffective data unit in the input instruction data unit subsequence is greater than or equal to a preset quantity threshold; and
removing the ineffective instruction data unit subsequence from the input data unit sequence to obtain a second updated data unit sequence, such that hardware resource overhead is reduced when an inference task or a training task of the large model is executed according to the second updated data unit sequence.

6. The method of claim 5, wherein the input instruction data unit subsequence is an input instruction token subsequence determined according to an input instruction sub-text in input data.

7. The method of claim 2, further comprising:
in response to determining that the candidate ineffective data unit satisfies a second preset condition, obtaining at least one training data unit sequence according to the candidate ineffective data unit, wherein the at least one training data unit sequence comprises at least one of: at least one first training data unit sequence or at least one second training data unit sequence, the first training data unit sequence is an input data unit sequence comprising the candidate ineffective data unit, and the second training data unit sequence is generated according to the candidate ineffective data unit; and
executing, by using the at least one hardware device, a training task of the large model according to the input data unit sequence comprising the candidate ineffective data unit, so as to increase at least one attention weight in the attention distribution information corresponding to the candidate ineffective data unit.

8. The method of claim 1, wherein the input data unit sequence is determined based on at least one of an input text, an input image, an input audio, or an input video, and the output data unit sequence is configured to be converted into at least one of an output text, an output image, an output audio, or an output video.

9. The method of claim 8, wherein the input data unit sequence comprises an input token sequence determined based on the input text, and the output data unit sequence is an output token sequence,
wherein the executing, by using at least one hardware device, an inference task of the large model according to the input data unit sequence comprises:
performing tokenization on the input text to obtain an input token sequence;
executing, by using the at least one hardware device, the inference task of the large model according to the input token sequence to obtain the output token sequence for the input token sequence and at least one attention distribution information respectively corresponding to at least one input token in the input token sequence; and
obtaining an output text according to the output token sequence.

10. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
execute, by using at least one hardware device, N inference tasks of a large model according to N input data unit sequences to obtain N attention distribution information sets and N output data unit sequences, wherein Nis an integer greater than or equal to 1, the large model comprises a plurality of processing blocks, the attention distribution information set comprises at least one attention distribution information respectively corresponding to at least one input data unit in the input data unit sequence, the output data unit sequence comprises at least one output data unit, the attention distribution information comprises at least one attention information for the input data unit, the attention information for the input data unit comprises at least one candidate attention weight, and the candidate attention weight is an attention weight between a first data representation of the input data unit in the processing block and a second data representation of the output data unit in the processing block; and
in response to determining that at least one first attention distribution information satisfying a first preset condition exists among a plurality of attention distribution information, determine at least one target ineffective data unit according to at least one first input data unit respectively corresponding to the at least one first attention distribution information,
wherein the first preset condition comprises: a proportion of ineffective weights in the attention distribution information being greater than or equal to a preset proportion threshold, wherein the ineffective weight is a candidate attention weight less than or equal to a preset weight threshold.

11. The electronic device of claim 10, wherein the at least one first input data unit comprises a plurality of first input data units, identical data units exist among the plurality of input data units, and the N input data unit sequences comprise M input data units,
wherein the at least one processor is further configured to:
obtain at least one candidate ineffective data unit and an ineffectiveness frequency information of the candidate ineffective data unit according to the plurality of first input data units, wherein the ineffectiveness frequency information is determined according to a first quantity of the candidate ineffective data unit and a second quantity of the candidate ineffective data unit, the first quantity is a quantity of the candidate ineffective data unit among the plurality of first input data units, and the second quantity is a quantity of the candidate ineffective data unit among the M input data units; and
determine a target ineffective data unit from the at least one candidate ineffective data unit according to at least one of: at least one type information or at least one ineffectiveness frequency information, wherein the type information indicates a type of the candidate ineffective data unit.

12. The electronic device of claim 11, wherein the at least one processor is further configured to perform at least one of:
determining the candidate ineffective data unit as the target ineffective data unit in response to determining that the ineffectiveness frequency information of the candidate ineffective data unit is greater than or equal to a preset ineffectiveness frequency threshold and determining that the candidate ineffective data unit fails to satisfy a second preset condition; and
determining the candidate ineffective data unit as the target ineffective data unit in response to determining that the ineffectiveness frequency information of the candidate ineffective data unit is less than the preset ineffectiveness frequency threshold,
wherein the second preset condition comprises at least one of:
an input effectiveness information of the candidate ineffective data unit indicating that the candidate ineffective data unit is effective; and
the candidate ineffectiveness frequency information being greater than or equal to a first preset ineffectiveness frequency threshold, and determining that the type information of the candidate ineffective data unit indicates that the candidate ineffective data unit is a verb, a logical connective, or a noun.

13. The electronic device of claim 12, wherein the at least one processor is further configured to:
remove the target ineffective data unit from the input data unit sequence to obtain a first updated data unit sequence, such that hardware resource overhead is reduced when an inference task or a training task of the large model is executed according to the first updated data unit sequence.

14. The electronic device of claim 12, wherein the input data unit sequence comprises an input instruction data unit subsequence and an input query data unit subsequence, and the at least one processor is further configured to:
determine the input instruction data unit subsequence as an ineffective instruction data unit subsequence in response to determining that a quantity of the target ineffective data unit in the input instruction data unit subsequence is greater than or equal to a preset quantity threshold; and
remove the ineffective instruction data unit subsequence from the input data unit sequence to obtain a second updated data unit sequence, such that hardware resource overhead is reduced when an inference task or a training task of the large model is executed according to the second updated data unit sequence.

15. The electronic device of claim 14, wherein the input instruction data unit subsequence is an input instruction token subsequence determined according to an input instruction sub-text in input data.

16. The electronic device of claim 11, wherein the at least one processor is further configured to:
in response to determining that the candidate ineffective data unit satisfies a second preset condition, obtain at least one training data unit sequence according to the candidate ineffective data unit, wherein the at least one training data unit sequence comprises at least one of: at least one first training data unit sequence or at least one second training data unit sequence, the first training data unit sequence is an input data unit sequence comprising the candidate ineffective data unit, and the second training data unit sequence is generated according to the candidate ineffective data unit; and
execute, by using the at least one hardware device, a training task of the large model according to the input data unit sequence comprising the candidate ineffective data unit, so as to increase at least one attention weight in the attention distribution information corresponding to the candidate ineffective data unit.

17. The electronic device of claim 10, wherein the input data unit sequence is determined based on at least one of an input text, an input image, an input audio, or an input video, and the output data unit sequence is configured to be converted into at least one of an output text, an output image, an output audio, or an output video.

18. The electronic device of claim 17, wherein the input data unit sequence comprises an input token sequence determined based on the input text, and the output data unit sequence is an output token sequence,
wherein the at least one processor is further configured to:
perform tokenization on the input text to obtain an input token sequence;
execute, by using the at least one hardware device, the inference task of the large model according to the input token sequence to obtain the output token sequence for the input token sequence and at least one attention distribution information respectively corresponding to at least one input token in the input token sequence; and
obtain an output text according to the output token sequence.

19. A non-transitory computer-readable storage medium having computer instructions stored thereon, wherein the computer instructions, when executed by a processor, are configured to cause a computer to:
execute, by using at least one hardware device, N inference tasks of a large model according to N input data unit sequences to obtain N attention distribution information sets and N output data unit sequences, wherein Nis an integer greater than or equal to 1, the large model comprises a plurality of processing blocks, the attention distribution information set comprises at least one attention distribution information respectively corresponding to at least one input data unit in the input data unit sequence, the output data unit sequence comprises at least one output data unit, the attention distribution information comprises at least one attention information for the input data unit, the attention information for the input data unit comprises at least one candidate attention weight, and the candidate attention weight is an attention weight between a first data representation of the input data unit in the processing block and a second data representation of the output data unit in the processing block; and
in response to determining that at least one first attention distribution information satisfying a first preset condition exists among a plurality of attention distribution information, determine at least one target ineffective data unit according to at least one first input data unit respectively corresponding to the at least one first attention distribution information,
wherein the first preset condition comprises: a proportion of ineffective weights in the attention distribution information being greater than or equal to a preset proportion threshold, wherein the ineffective weight is a candidate attention weight less than or equal to a preset weight threshold.

20. The storage medium of claim 19, wherein the at least one first input data unit comprises a plurality of first input data units, identical data units exist among the plurality of input data units, and the N input data unit sequences comprise M input data units,
wherein the computer instructions, when executed by the processor, are further configured to cause the computer to:
obtain at least one candidate ineffective data unit and an ineffectiveness frequency information of the candidate ineffective data unit according to the plurality of first input data units, wherein the ineffectiveness frequency information is determined according to a first quantity of the candidate ineffective data unit and a second quantity of the candidate ineffective data unit, the first quantity is a quantity of the candidate ineffective data unit among the plurality of first input data units, and the second quantity is a quantity of the candidate ineffective data unit among the M input data units; and
determine a target ineffective data unit from the at least one candidate ineffective data unit according to at least one of: at least one type information or at least one ineffectiveness frequency information, wherein the type information indicates a type of the candidate ineffective data unit.
